(19) United States
(12) Patent Application Publication
(10) Pub. No.: US 2016/0282973 A1
(43) Pub. Date: Sep. 29, 2016

(54) METAL MESH TOUCH SENSOR WITH RANDOMIZED CHANNEL DISPLACEMENT

(71) Applicant: Uni-Pixel Display, Inc., The Woodlands, TX (US)

(72) Inventors: Arnold Kholodenko, San Francisco, CA (US); Hong Shu, The Woodlands, TX (US); Mark Wendt, Houston, TX (US); Kenneth B. Frame, Spring, TX (US); Francisco D. Saldana, Houston, TX (US)

(21) Appl. No.: 14/680,974

(22) Filed: Apr. 7, 2015

Related U.S. Application Data
(63) Continuation-in-part of application No. 14/680,763, filed on Apr. 7, 2015.
(60) Provisional application No. 62/137,771, filed on Mar. 24, 2015.
(60) Provisional application No. 62/137,780, filed on Mar. 24, 2015.

(51) Int. Cl. G06F 3/041

(52) U.S. Cl. CPC G06F 3/041

(57) ABSTRACT

A method of designing a metal mesh touch sensor with randomized channel displacement includes generating a representation of a first conductive pattern. The representation of the first conductive pattern is partitioned into a plurality of representations of column channels. A random channel displacement is applied to at least one column channel. A representation of a second conductive pattern is generated. The representation of the second conductive pattern is partitioned into a plurality of representations of row channels. A random channel displacement is applied to at least one row channel.

### CROSS-REFERENCE TO RELATED APPLICATIONS

This application claims the benefit of, or priority to, U.S. Provisional Patent Application Ser. No. 62/137,771, filed on Mar. 24, 2015, and is a continuation-in-part of U.S. patent application Ser. No. 14/680,763, filed on Apr. 7, 2015, which claims the benefit of, or priority to, U.S. Provisional Patent Application Ser. No. 62/137,780, filed on Mar. 24, 2015, all of which are hereby incorporated by reference in their entirety.

### BACKGROUND OF THE INVENTION

A touch screen enabled system allows a user to control various aspects of the system by touch or gestures on the screen. A user may interact directly with one or more objects depicted on a display device by touch or gestures that are sensed by a touch sensor. The touch sensor typically includes a conductive pattern disposed on a substrate configured to sense touch. Touch screens are commonly used in consumer, commercial, and industrial systems.

### BRIEF SUMMARY OF THE INVENTION

According to one aspect of one or more embodiments of the present invention, a method of designing a metal mesh touch sensor with randomized channel displacement includes generating a representation of a first conductive pattern. The representation of the first conductive pattern is partitioned into a plurality of representations of column channels. A random channel displacement is applied to at least one column channel. A representation of a second conductive pattern is generated. The representation of the second conductive pattern is partitioned into a plurality of representations of row channels. A random channel displacement is applied to at least one row channel.

According to one aspect of one or more embodiments of the present invention, a metal mesh touch sensor with randomized channel displacement includes a transparent substrate, a first conductive pattern disposed on a first side of the transparent substrate, and a second conductive pattern disposed on a second side of the transparent substrate. The first conductive pattern is partitioned into a plurality of column channels and at least one column channel has a random channel displacement. The second conductive pattern is partitioned into a plurality of row channels and at least one row channel has a random channel displacement.

According to one aspect of one or more embodiments of the present invention, a metal mesh touch sensor with randomized channel displacement includes a first transparent substrate, a first conductive pattern disposed on a side of the first transparent substrate, a second transparent substrate, and a second conductive pattern disposed on a side of the second transparent substrate. The first conductive pattern is partitioned into a plurality of column channels and at least one column channel has a random channel displacement. The second conductive pattern is partitioned into a plurality of row channels and at least one row channel has a random channel displacement. The first transparent substrate is bonded to the second transparent substrate.

Other aspects of the present invention will be apparent from the following description and claims.

### BRIEF DESCRIPTION OF THE DRAWINGS

FIG. 1 shows a cross section of a touch screen in accordance with one or more embodiments of the present invention.

FIG. 2 shows a schematic view of a touch screen enabled system in accordance with one or more embodiments of the present invention.

FIG. 3 shows a functional representation of a touch sensor as part of a touch screen in accordance with one or more embodiments of the present invention.

FIG. 4 shows a cross-section of a touch sensor with conductive patterns disposed on opposing sides of a transparent substrate in accordance with one or more embodiments of the present invention.

FIG. 5A shows a first conductive pattern disposed on a transparent substrate in accordance with one or more embodiments of the present invention.

FIG. 5B shows a second conductive pattern disposed on a transparent substrate in accordance with one or more embodiments of the present invention.

FIG. 5C shows a mesh area of a metal mesh touch sensor in accordance with one or more embodiments of the present invention.

FIG. 6A shows a portion of a representation of a first conductive pattern in accordance with one or more embodiments of the present invention.

FIG. 6B shows a portion of a representation of a first conductive pattern with channel breaks in accordance with one or more embodiments of the present invention.

FIG. 6C shows a portion of a representation of a second conductive pattern in accordance with one or more embodiments of the present invention.

FIG. 6D shows a portion of a representation of a second conductive pattern with channel breaks in accordance with one or more embodiments of the present invention.

FIG. 6E shows a portion of a metal mesh touch sensor in accordance with one or more embodiments of the present invention.

FIG. 7A shows a portion of a representation of a first conductive pattern in accordance with one or more embodiments of the present invention.

FIG. 7B shows a portion of a representation of a first conductive pattern with a random channel displacement in accordance with one or more embodiments of the present invention.

FIG. 7C shows a zoomed in view of a portion of a representation of a first conductive pattern with a random channel displacement in accordance with one or more embodiments of the present invention.

FIG. 7D shows a portion of a representation of a second conductive pattern in accordance with one or more embodiments of the present invention.

FIG. 7E shows a portion of a representation of a second conductive pattern with a random channel displacement in accordance with one or more embodiments of the present invention.

FIG. 7F shows a zoomed in view of a portion of a representation of a second conductive pattern with a random channel displacement in accordance with one or more embodiments of the present invention.

FIG. 7G shows a portion of a metal mesh touch sensor with randomized channel displacement in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

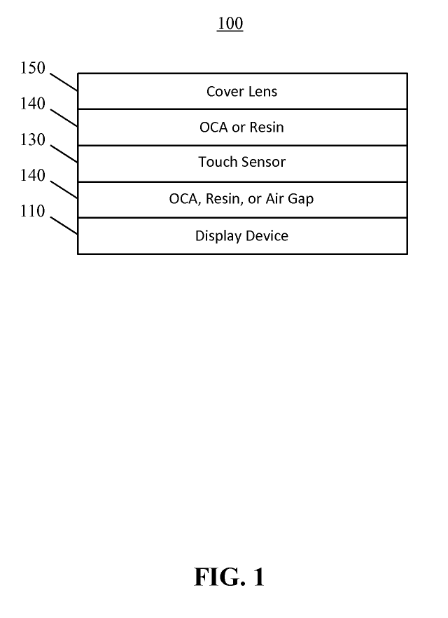

FIG. 1 shows a cross-section of a touch screen 100 in accordance with one or more embodiments of the present invention. Touch screen 100 includes a display device 110 and a touch sensor 130 that overlays at least a portion of a viewable area of display device 110. In certain embodiments, an optically clear adhesive (“OCA”) or resin 140 may bond a bottom side of touch sensor 130 to a top, or user-facing, side of display device 110. In other embodiments, an isolation layer or air gap 140 may separate the bottom side of touch sensor 130 from the top, or user-facing, side of display device 110. A transparent cover lens 150 may overlay a top, or user-facing, side of touch sensor 130. The transparent cover lens 150 may be composed of polyester, glass, or any other material suitable for use as a cover lens 150. In certain embodiments, an OCA or resin 140 may bond a bottom side of the transparent cover lens 150 to the top, or user-facing, side of touch sensor 130. A top side of transparent cover lens 150 faces the user and protects the underlying components of touch screen 100. One of ordinary skill in the art will recognize that the components and/or the stack up of touch screen 100 may vary based on an application or design in accordance with one or more embodiments of the present invention. One of ordinary skill in the art will recognize that touch sensor 130, or the function that it implements, may be integrated into the display device 110 stack up (not independently illustrated) in accordance with one or more embodiments of the present invention.

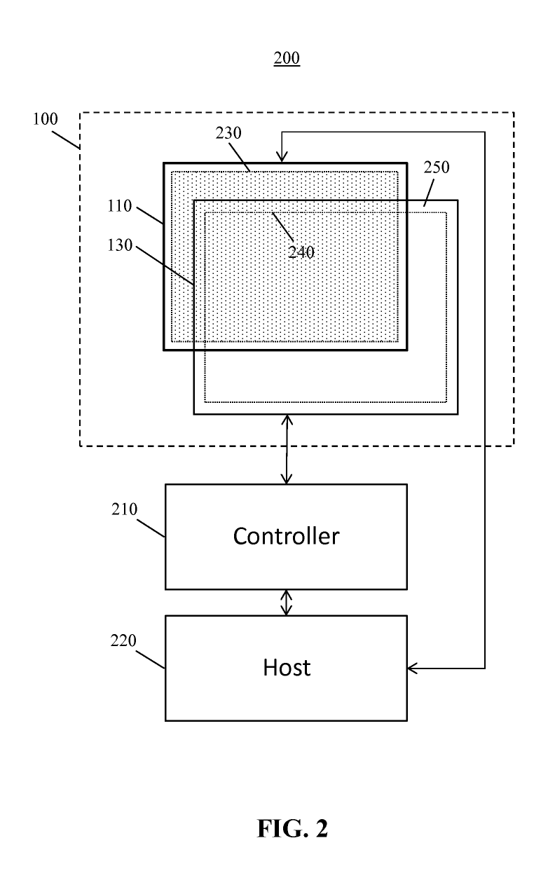

FIG. 2 shows a schematic view of a touch screen enabled system 200 in accordance with one or more embodiments of the present invention. Touch screen enabled system 200 may be a consumer, commercial, or industrial system including, but not limited to, a smartphone, tablet computer, laptop computer, desktop computer, server computer, printer, monitor, television, appliance, application specific device, kiosk, automatic teller machine, copier, desktop phone, automotive display system, portable gaming device, gaming console, or other application or design suitable for use with touch screen 100.

Touch screen enabled system 200 may include one or more printed circuit boards (not shown) or flexible circuits (not shown) on which one or more processors (not shown), system memory (not shown), and other system components (not shown) may be disposed. Each of the one or more processors may be a single-core processor (not shown) or a multi-core processor (not shown) capable of executing software instructions. Multi-core processors typically include a plurality of processor cores disposed on the same physical die (not shown) or a plurality of processor cores disposed on multiple die (not shown) disposed within the same mechanical package (not shown). System 200 may include one or more input/output devices (not shown), one or more local storage devices (not shown) including a solid-state drive, a solid-state drive array, a fixed disk drive, a fixed disk drive array, or any other non-transitory computer readable medium, a network interface device (not shown), and/or one or more network storage devices (not shown) including a network-attached storage device or a cloud-based storage device.

In certain embodiments, touch screen 100 may include touch sensor 130 that overlays at least a portion of a viewable area 230 of display device 110. Touch sensor 130 may include a viewable area 240 that corresponds to that portion of the touch sensor 130 that overlays the light emitting pixels (not shown) of display device 110 (e.g., viewable area 230 of display device 110). Touch sensor 130 may include a bezel circuit area 250 outside at least one side of the viewable area 240 of touch sensor 130 that provides connectivity (not independently illustrated) between touch sensor 130 and a controller 210. In other embodiments, touch sensor 130, or the function that it implements, may be integrated into display device 110 (not independently illustrated). Controller 210 electrically drives at least a portion of touch sensor 130. Touch sensor 130 senses touch (capacitance, resistance, optical, acoustic, or other technology) and conveys information corresponding to the sensed touch to controller 210.

The manner in which the sensing of touch is measured, tuned, and/or filtered may be configured by controller 210. In addition, controller 210 may recognize one or more gestures based on the sensed touch or touches. Controller 210 provides host 220 with touch or gesture information corresponding to the sensed touch or touches. Host 220 may use this touch or gesture information as user input and the system 200 may respond in an appropriate manner. In this way, the user may interact with touch screen enabled system 200 by touch or gestures on touch screen 100. In certain embodiments, host 220 may be the one or more printed circuit boards (not shown) or flexible circuits (not shown) on which the one or more processors (not shown) are disposed. In other embodiments, host 220 may be a subsystem (not shown) or any other part of system 200 (not shown) that is configured to interface with display device 110 and controller 210. One of ordinary skill in the art will recognize that the components and the configuration of the components of touch screen enabled system 200 may vary based on an application or design in accordance with one or more embodiments of the present invention.

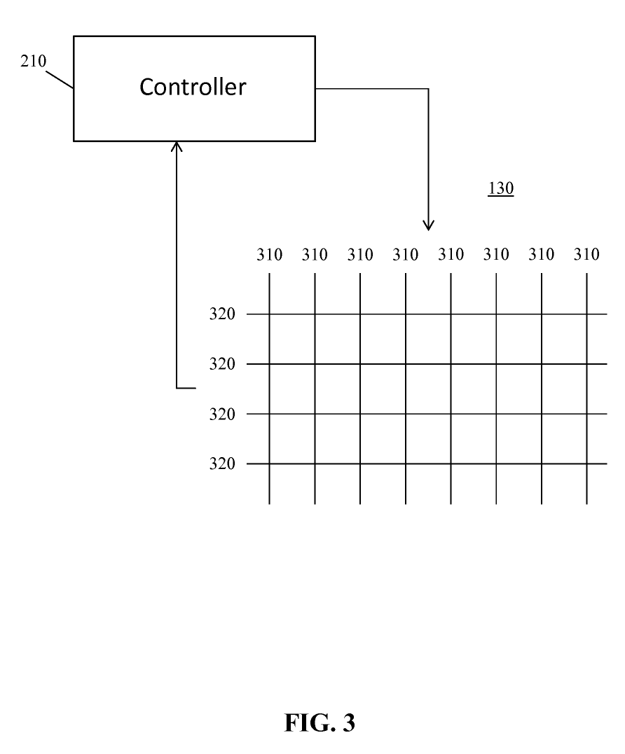

FIG. 3 shows a functional representation of a touch sensor 130 as part of a touch screen 100 in accordance with one or more embodiments of the present invention. In certain embodiments, touch sensor 130 may be viewed as a plurality of column channels 310 and a plurality of row channels 320. The plurality of column channels 310 and the plurality of row channels 320 may be separated from one another by, for example, a dielectric or substrate (not shown) on which they may be disposed. The number of column channels 310 and the number of row channels 320 may or may not be the same and may vary based on an application or a design. The apparent intersections of column channels 310 and row channels 320 may be viewed as uniquely addressable locations of touch sensor 130. In operation, controller 210 may electrically drive one or more row channels 320 and touch sensor 130 may sense touch on one or more column channels 310 that are sampled by controller 210. One of ordinary skill in the art will recognize that the role of row channels 320 and column channels 310 may be reversed such that controller 210 electrically drives one or more column channels 310 and touch sensor 130 senses touch on one or more row channels 320 that are sampled by controller 210.

In certain embodiments, controller 210 may interface with touch sensor 130 by a scanning process. In such an embodiment, controller 210 may electrically drive a selected row channel 320 (or column channel 310) and sample all column channels 310 (or row channels 320) that intersect the selected row channel 320 (or the selected column channel 310) by sensing, for example, changes in capacitance. The change in capacitance may be used to determine the location of the touch or touches. This process may be continued through all row channels 320 (or all column channels 310) such that changes in capacitance are measured at each uniquely addressable location of touch sensor 130 at predetermined intervals. Controller 210 may allow for the adjustment of the scan rate depending on the needs of a particular application or design. In other embodiments, controller 210 may interface with touch sensor 130 by an interrupt driven process. In such an embodiment, a touch or a gesture generates an interrupt to controller 210 that triggers controller 210 to read one or more of its own registers that store sensed touch information sampled from touch sensor 130 at predetermined intervals. One of ordinary skill in the art will recognize that the mechanism by which touch or gestures are sensed by touch sensor 130 and sampled by controller 210 may vary based on an application or a design in accordance with one or more embodiments of the present invention.

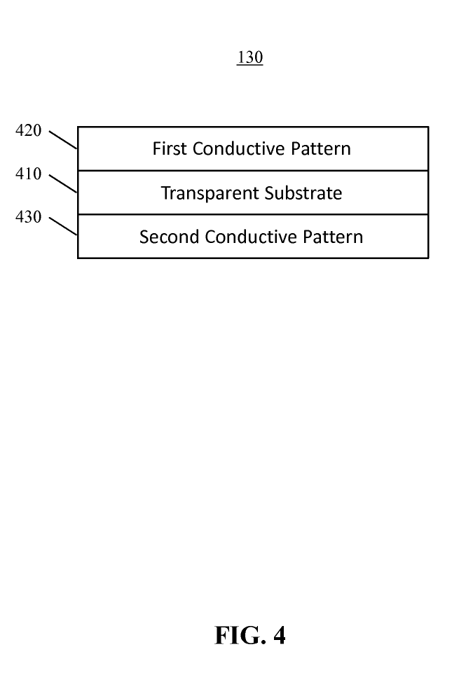

FIG. 4 shows a cross-section of a touch sensor 130 with conductive patterns 420 and 430 disposed on opposing sides of a transparent substrate 410 in accordance with one or more embodiments of the present invention. In certain embodiments, touch sensor 130 may include a first conductive pattern 420 disposed on a top, or user-facing, side of a transparent substrate 410 and a second conductive pattern 430 disposed on a bottom side of the transparent substrate 410. The first conductive pattern 420 and the second conductive pattern 430 may include different, substantially similar, or identical patterns of conductors depending on the application or design. The first conductive pattern 420 may overlay the second conductive pattern 430 at a predetermined alignment that may include an offset. One of ordinary skill in the art will recognize that a conductive pattern may be any shape or pattern of one or more conductors (not shown) in accordance with one or more embodiments of the present invention. One of ordinary skill in the art will also recognize that any type of touch sensor 130 conductor, including, for example, metal conductors, metal mesh conductors, indium tin oxide (“ITO”) conductors, poly(3,4-ethylenedioxythiophene (“PEDOT”) conductors, carbon nanotube conductors, silver nanowire conductors, or any other conductors may be used in accordance with one or more embodiments of the present invention. However, one of ordinary skill in the art will recognize that non-transparent conductors, such as those used in metal mesh touch sensors, are prone to problematic Moiré interference.

One of ordinary skill in the art will recognize that other touch sensor 130 stack ups (not shown) may be used in accordance with one or more embodiments of the present invention. For example, single-sided touch sensor 130 stack ups may include conductors disposed on a single side of a substrate 410 where conductors that cross are isolated from one another by a dielectric material (not shown), such as, for example, as used in On Glass Solution (“OGS”) touch sensor 130 embodiments. Double-sided touch sensor 130 stack ups may include conductors disposed on opposing sides of the same substrate 140 (as shown in FIG. 4) or bonded touch sensor 130 embodiments (not shown) where conductors are disposed on at least two different sides of at least two different substrates 410. Bonded touch sensor 130 stack ups may include, for example, two single-sided substrates 410 bonded together (not shown), one double-sided substrate 410 bonded to a single-sided substrate 410 (not shown), or a double-sided substrate 410 bonded to another double-sided substrate 410 (not shown). One of ordinary skill in the art will recognize that other touch sensor 130 stack ups, including those that vary in the number, type, organization, and/or configuration of substrate(s) and/or conductive pattern(s) are within the scope of one or more embodiments of the present invention. One of ordinary skill in the art will also recognize that one or more of the above-noted touch sensor 130 stack ups may be used in applications where touch sensor 130 is integrated into display device 110 in accordance with one or more embodiments of the present invention.

A conductive pattern 420 or 430 may be disposed on one or more transparent substrates 410 by any process suitable for disposing conductive lines or features on a substrate. Suitable processes may include, for example, printing processes, vacuum-based deposition processes, solution coating processes, or cure/etch processes that either form conductive lines or features on substrate or form seed lines or features on substrate that may be further processed to form conductive lines or features on substrate. Printing processes may include flexographic printing, including the flexographic printing of a catalytic ink that may be metallized by an electroless plating process to plate a metal on top of the printed catalytic ink or direct flexographic printing of conductive ink or other materials capable of being flexographically printed, gravure printing, inkjet printing, rotary printing, or stamp printing. Deposition processes may include pattern-based deposition, chemical vapor deposition, electro deposition, epitaxy, physical vapor deposition, or casting. Cure/etch processes may include optical or UV-based photolithography, e-beam/ion-beam lithography, x-ray lithography, interference lithography, scanning probe lithography, imprint lithography, or magneto lithography. One of ordinary skill in the art will recognize that any process or combination of processes, suitable for disposing conductive lines or features on substrate, may be used in accordance with one or more embodiments of the present invention.

With respect to transparent substrate 410, transparent means capable of transmitting a substantial portion of visible light through the substrate suitable for a given touch sensor application or design. In typical touch sensor applications, transparent means transmittance of at least 85% of incident visible light through the substrate. However, one of ordinary skill in the art will recognize that other transmittance values may be desirable for other touch sensor applications or designs. In certain embodiments, transparent substrate 410 may be polyethylene terephthalate (“PET”), polyethylene naphthalate (“PEN”), cellulose acetate (“TAC”), cycloaliphatic hydrocarbons (“COP”), polymethylmethacrylates (“PMMA”), polyimide (“PI”), bi-axially-oriented polypropylene (“BOPP”), polyester, polycarbonate, glass, copolymers, blends, or combinations thereof. In other embodiments, transparent substrate 410 may be any other transparent material suitable for use as a touch sensor substrate. One of ordinary skill in the art will recognize that the composition of transparent substrate 410 may vary based on an application or design in accordance with one or more embodiments of the present invention.

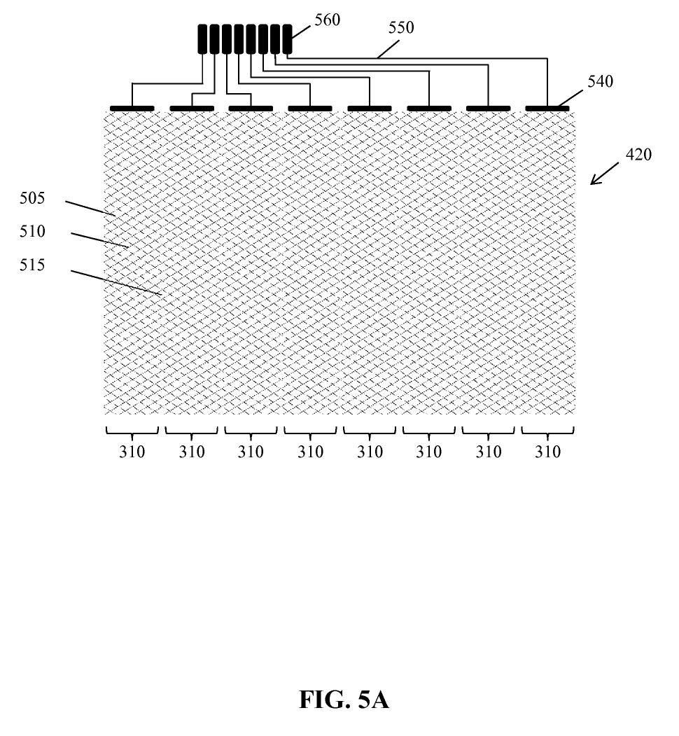

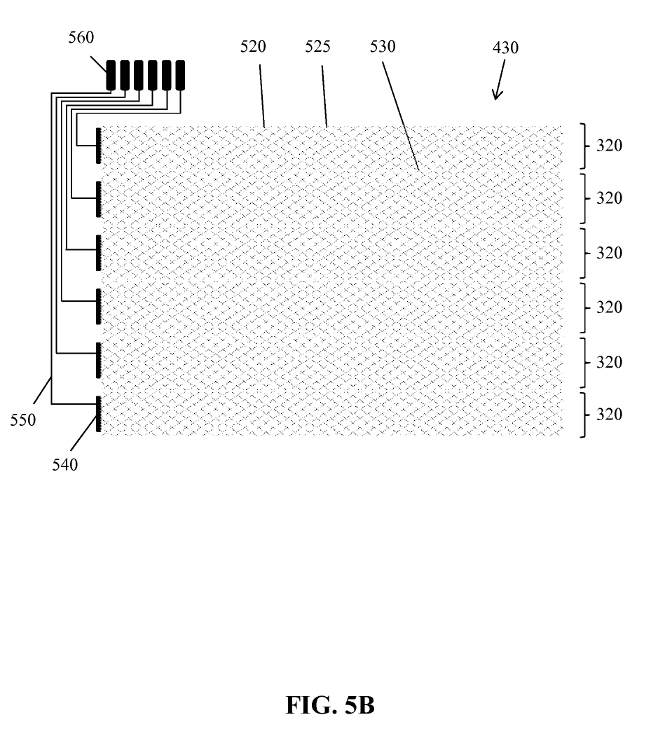

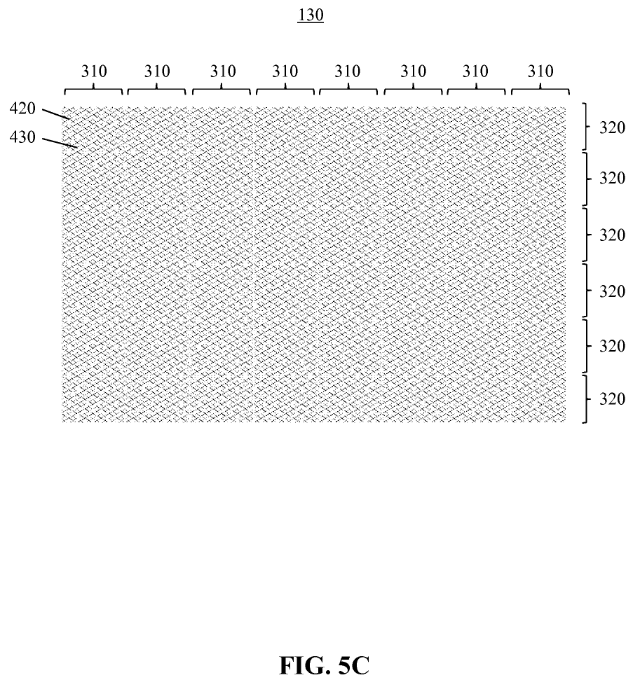

FIG. 5A shows a first conductive pattern 420 disposed on a transparent substrate (e.g., transparent substrate 410) in accordance with one or more embodiments of the present invention. In certain embodiments, first conductive pattern 420 may include a mesh formed by a first plurality of parallel conductive lines oriented in a first direction 505 and a first plurality of parallel conductive lines oriented in a second direction 510 that are disposed on a side of a transparent substrate (e.g., transparent substrate 410). One of ordinary skill in the art will recognize that the number of parallel conductive lines oriented in the first direction 505 and/or the number of parallel conductive lines oriented in the second direction 510 may or may not be the same and may vary based on an application or design. One of ordinary skill in the art will also recognize that a size of first conductive pattern 420 may vary based on an application or a design. In other embodiments, first conductive pattern 420 may include any other shape or pattern formed by one or more conductive lines or features (not independently illustrated). One of ordinary skill in the art will recognize that first conductive pattern 420 is not limited to parallel conductive lines and may comprise any one or more of a predetermined orientation of line segments, a random orientation of line segments, curved line segments, conductive particles, polygons, or any other shape(s) or pattern(s) comprised of electrically conductive material (not independently illustrated) in accordance with one or more embodiments of the present invention.

In certain embodiments, the first plurality of parallel conductive lines oriented in the first direction 505 may be perpendicular to the first plurality of parallel conductive lines oriented in the second direction 510, thereby forming a rectangle-type mesh. In other embodiments, the first plurality of parallel conductive lines oriented in the first direction 505 may be angled (not shown) relative to the first plurality of parallel conductive lines oriented in the second direction 510, thereby forming a parallelogram-type mesh. One of ordinary skill in the art will recognize that the relative angle between the first plurality of parallel conductive lines oriented in the first direction 505 and the first plurality of parallel conductive lines oriented in the second direction 510 may vary based on an application or a design in accordance with one or more embodiments of the present invention.

In certain embodiments, a first plurality of channel breaks 515 may partition first conductive pattern 420 into a plurality of column channels 310, each electrically isolated from the others (no electrical continuity). One of ordinary skill in the art will recognize that the number of channel breaks 515, the number of column channels 310, and/or the width of the column channels 310 may vary based on an application or design in accordance with one or more embodiments of the present invention. Each column channel 310 may route to a channel pad 540. Each channel pad 540 may route via one or more interconnect conductive lines 550 to an interface connector 560. Interface connectors 560 may provide a connection interface between a touch sensor (e.g., 130 of FIG. 2) and a controller (e.g., 210 of FIG. 2).

FIG. 5B shows a second conductive pattern 430 disposed on a transparent substrate (e.g., transparent substrate 410) in accordance with one or more embodiments of the present invention. In certain embodiments, second conductive pattern 430 may include a mesh formed by a second plurality of parallel conductive lines oriented in a first direction 520 and a second plurality of parallel conductive lines oriented in a second direction 525 that are disposed on a side of a transparent substrate (e.g., transparent substrate 410). One of ordinary skill in the art will recognize that the number of parallel conductive lines oriented in the first direction 520 and/or the number of parallel conductive lines oriented in the second direction 525 may vary based on an application or design. The second conductive pattern 430 may be substantially similar in size to the first conductive pattern 420. One of ordinary skill in the art will recognize that a size of the second conductive pattern 430 may vary based on an application or a design. In other embodiments, second conductive pattern 430 may include any other shape or pattern formed by one or more conductive lines or features (not independently illustrated). One of ordinary skill in the art will also recognize that second conductive pattern 430 is not limited to parallel conductive lines and could be any one or more of a predetermined orientation of line segments, a random orientation of line segments, curved line segments, conductive particles, polygons, or any other shape(s) or pattern(s) comprised of electrically conductive material (not independently illustrated) in accordance with one or more embodiments of the present invention.

In certain embodiments, the second plurality of parallel conductive lines oriented in the first direction 520 may be perpendicular to the second plurality of parallel conductive lines oriented in the second direction 525, thereby forming a rectangle-type mesh. In other embodiments, the second plurality of parallel conductive lines oriented in the first direction 520 may be angled (not shown) relative to the second plurality of parallel conductive lines oriented in the second direction 525, thereby forming a parallelogram-type mesh. One of ordinary skill in the art will recognize that the relative angle between the second plurality of parallel conductive lines oriented in the first direction 520 and the second plurality of parallel conductive lines oriented in the second direction 525 may vary based on an application or a design in accordance with one or more embodiments of the present invention.

In certain embodiments, a plurality of channel breaks 530 may partition second conductive pattern 430 into a plurality of row channels 320, each electrically isolated from the others (no electrical continuity). One of ordinary skill in the art will recognize that the number of channel breaks 530, the number of row channels 320, and/or the width of the row channels 320 may vary based on an application or design in accordance with one or more embodiments of the present invention. Each row channel 320 may route to a channel pad 540. Each channel pad 540 may route via one or more interconnect conductive lines 550 to an interface connector 560. Interface connectors 560 may provide a connection interface between a touch sensor (e.g., 130 of FIG. 2) and a controller (e.g., 210 of FIG. 2).

FIG. 5C shows a mesh area of a metal mesh touch sensor 130 in accordance with one or more embodiments of the present invention. In certain embodiments, a touch sensor 130 may be formed, for example, by disposing a first conductive pattern 420 on a top, or user-facing, side of a transparent substrate (e.g., transparent substrate 410) and disposing a second conductive pattern 430 on a bottom side of the transparent substrate (e.g., transparent substrate 410). In other embodiments, a touch sensor 130 may be formed, for example, by disposing a first conductive pattern 420 on a side of a first transparent substrate (e.g., transparent substrate 410), disposing a second conductive pattern 430 on a side of a second transparent substrate (e.g., transparent substrate 410), and bonding the first transparent substrate to the second transparent substrate. One of ordinary skill in the art will recognize that the disposition of the conductive pattern or patterns may vary based on the touch sensor 130 stack up in accordance with one or more embodiments of the present invention. In embodiments that use two conductive patterns, the first conductive pattern 420 and the second conductive pattern 430 may be offset vertically, horizontally, and/or angularly relative to one another. The offset between the first conductive pattern 420 and the second conductive pattern 430 may vary based on an application or a design. One of ordinary skill in the art will recognize that the first conductive pattern 420 and the second conductive pattern 430 may be disposed on substrate or substrates 410 using any process or processes suitable for disposing the conductive patterns on the substrate or substrates 410 in accordance with one or more embodiments of the present invention.

In certain embodiments, the first conductive pattern 420 may include a first plurality of parallel conductive lines oriented in a first direction (e.g., 505 of FIG. 5A) and a first plurality of parallel conductive lines oriented in a second direction (e.g., 510 of FIG. 5A) that form a mesh that is partitioned by a first plurality of channel breaks (e.g., 515 of FIG. 5A) into electrically partitioned column channels 310. In certain embodiments, the second conductive pattern 430 may include a second plurality of parallel conductive lines oriented in a first direction (e.g., 520 of FIG. 5B) and a second plurality of parallel conductive lines oriented in a second direction (e.g., 525 of FIG. 5B) that form a mesh that is partitioned by a second plurality of channel breaks (e.g., 530 of FIG. 5B) into electrically partitioned row channels 320. In operation, a controller (e.g., 210 of FIG. 2) may electrically drive one or more row channels 320 (or column channels 310) and touch sensor 130 senses touch on one or more column channels 310 (or row channels 320). In other embodiments, the disposition and/or the role of the first conductive pattern 420 and the second conductive pattern 430 may be reversed.

In certain embodiments, one or more of the plurality of parallel conductive lines oriented in the first direction (e.g., 505 of FIG. 5A, 520 of FIG. 5B) and one or more of the plurality of parallel conductive lines oriented in the second direction (e.g., 510 of FIG. 5A, 525 of FIG. 5A) may have a line width that varies based on an application or design, including, for example, micrometer-fine line widths. In addition, the number of parallel conductive lines oriented in the first direction (e.g., 505 of FIG. 5A, 520 of FIG. 5B), the number of parallel conductive lines oriented in the second direction (e.g., 510 of FIG. 5A, 525 of FIG. 5B), and the line-to-line spacing between them may vary based on an application or a design. One of ordinary skill in the art will recognize that the size, configuration, and design of each conductive pattern 420, 430 may vary based on an application or a design in accordance with one or more embodiments of the present invention. One of ordinary skill in the art will also recognize that touch sensor 130 depicted in FIG. 5C is illustrative but not limiting and that the size, shape, and design of the touch sensor 130 is such that there is substantial transmission of an image (not shown) of an underlying display device (e.g., 110 of FIG. 1) in actual use that is not shown in the drawing.

In one or more embodiments of the present invention, a method of designing a metal mesh touch sensor with randomized channel displacement may be performed using existing software tools used to design a representation of a conductive pattern. A representation of a conductive pattern is a drawing of the pattern that may be generated in a software application, such as, for example, a computer-aided drafting (“CAD”) software application. The representation of the conductive pattern may be used as part of a larger process to fabricate the conductive pattern as part of the fabrication of a touch sensor. In certain embodiments, the representation of the conductive pattern may have a plurality of virtual layers that partition the representation of the conductive pattern to facilitate fabrication of the conductive pattern. For example, in certain embodiments, the representation of the conductive pattern may include a plurality of representations of parallel conductive lines oriented in a first direction on one virtual layer and a plurality of representations of parallel conductive lines oriented in a second direction on another virtual layer. In this way, the representation of the conductive pattern may be partitioned into distinct layers that correspond to a distinct number of flexographic printing plates that may be used to print a catalytic ink image of the representation of the conductive pattern on substrate.

In certain embodiments, the one or more layers of the representation of the conductive pattern may be used to form one or more thermal imaging layers. The one or more thermal imaging layers may be used to fabricate one or more flexographic printing plates used in one or more flexographic printing stations of a multi-station flexographic printing system. The one or more flexographic printing stations may be used to print a catalytic ink image of the representation of the conductive pattern, in a layer-by-layer manner, on substrate. The printed catalytic ink image of the representation of the conductive pattern may be metallized by one or more electroless plating processes or other metallization processes that metalize the printed catalytic ink image, thereby forming the conductive pattern on substrate. The conductive pattern is then capable of serving an electrical function as part of a touch sensor as discussed herein.

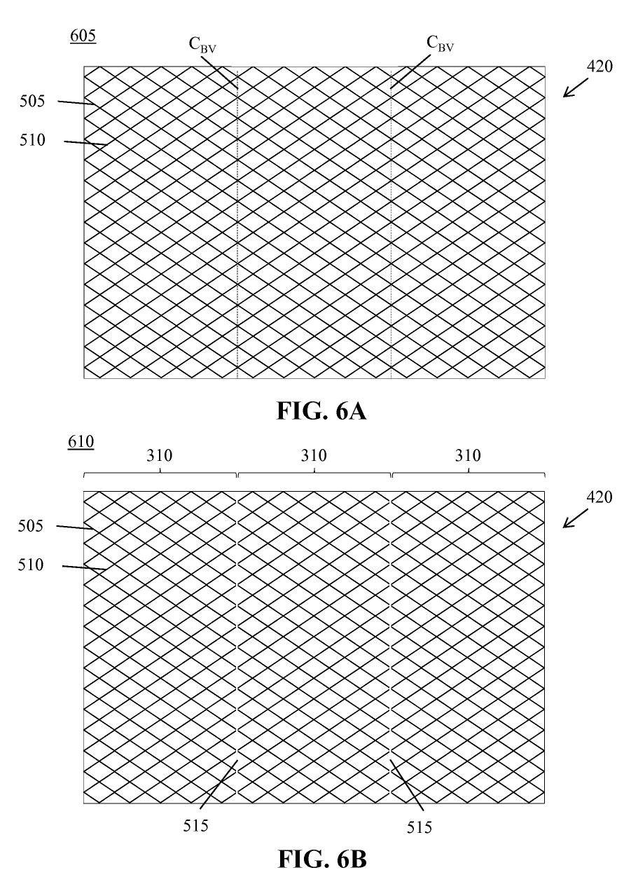

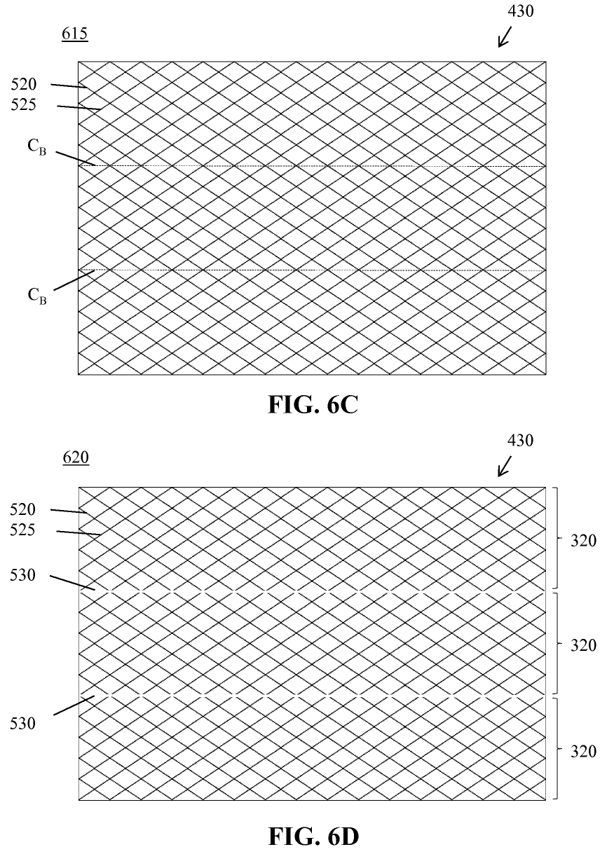

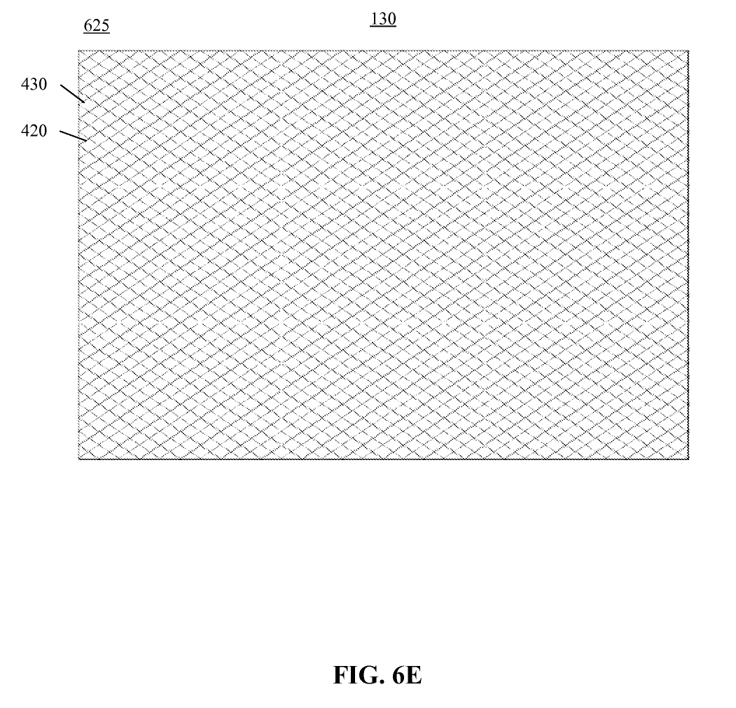

FIG. 6A shows a portion 605 of a representation of a first conductive pattern 420 in accordance with one or more embodiments of the present invention. The representation of the first conductive pattern 420 may be generated in a software application by placing a first plurality of representations of parallel conductive lines oriented in a first direction 505, where the representations of the parallel conductive lines oriented in the first direction 505 have a fixed line width and a fixed pitch, or line-to-line spacing, between adjacent representations of parallel conductive lines oriented in the first direction 505. A first plurality of representations of parallel conductive lines oriented in a second direction 510 may be placed, where the representations of the parallel conductive lines oriented in the second direction 510 have a fixed line width and a fixed pitch between adjacent representations of parallel conductive lines oriented in the second direction 510. The first plurality of representations of parallel conductive lines oriented in the first direction 505 and the first plurality of representations of parallel conductive lines oriented in the second direction 510 may intersect at an angle that may vary, forming either a rectangle-type mesh (not shown) or parallelogram-type mesh (as depicted in FIG. 6A). A first plurality of channel break voids, C_{BV}, may be placed in user-defined locations where channel breaks (e.g., 515 of FIG. 5A) are desired. The channel break voids, C_{BV}, are used to void those portions of the representations of parallel conductive lines 505, 510 that they are in contact with, rendering those portions of the representations of parallel conductive lines 505, 510 as not present in the location of the voids, C_{BV}, breaking connectivity. In this way, the voids, C_{BV}, may be used to facilitate the design of the mesh prior to formation of representations of channel breaks and column channels (not shown).

Continuing, FIG. 6B shows a portion 610 of a representation of a first conductive pattern 420 with channel breaks 515 in accordance with one or more embodiments of the present invention. The first plurality of channel break voids (C_{BV} of FIG. 6A) may be used to form a first plurality of representations of channel breaks 515 that partition the representation of the first conductive pattern 420 into a plurality of representations of column channels 310.

Continuing, FIG. 6C shows portion 615 of a representation of a second conductive pattern 430 in accordance with one or more embodiments of the present invention. The representation of the second conductive pattern 430 may be generated in a software application by placing a second plurality of representations of parallel conductive lines oriented in a first direction 520, where the representations of the parallel conductive lines oriented in the first direction 520 have a fixed line width and a fixed pitch between adjacent representations of parallel conductive lines oriented in the first direction 520. A second plurality of representations of parallel conductive lines oriented in a second direction 525 may be placed, where the representations of the parallel conductive lines oriented in the second direction 525 have a fixed line width and a fixed pitch between adjacent representations of parallel conductive lines oriented in the second direction 525. The second plurality of representations of parallel conductive lines oriented in the first direction 520 and the second plurality of representations of parallel conductive lines oriented in the second direction 525 may intersect at an angle that may vary, forming either a rectangle-type mesh (not shown) or parallelogram-type mesh (as depicted in FIG. 6C). A second plurality of channel break voids, C_{BV}, may be placed in user-defined locations where channel breaks (e.g., 530 of FIG. 5B) are desired. The channel break voids, C_{BV}, are used to void those portions of the representations of parallel conductive lines 520, 525 that they are in contact with, rendering those portions of the representations of parallel conductive lines 520, 525 as not present in the location of the voids, C_{BV}, breaking connectivity. In this way, the voids, C_{BV}, may be used to facilitate the design of the mesh prior to formation of representations of channel breaks and row channels (not shown).

Continuing, FIG. 6D shows a portion 620 of a representation of a second conductive pattern 430 with channel breaks 530 in accordance with one or more embodiments of the present invention. The second plurality of channel break voids may be used to form a second plurality of representations of channel breaks 530 that partition the representation of the second conductive pattern 430 into a plurality of representations of row channels 320.

Continuing, FIG. 6E shows a portion 625 of a metal mesh touch sensor 130 with channel breaks in accordance with one or more embodiments of the present invention. Touch sensor 130 may be formed, for example, by disposing a first conductive pattern 420 on a top, or user-facing, side of a transparent substrate (e.g., transparent substrate 410) and disposing a second conductive pattern 430 on a bottom side of the transparent substrate (e.g., transparent substrate 410). In other embodiments, a touch sensor 130 may be formed, for example, by disposing a first conductive pattern 420 on a side of a first transparent substrate (e.g., transparent substrate 410), disposing a second conductive pattern 430 on a side of a second transparent substrate (e.g., transparent substrate 410), and bonding the first transparent substrate to the second transparent substrate. One of ordinary skill in the art will recognize that the disposition of the conductive pattern or patterns may vary based on the touch sensor 130 stack up in accordance with one or more embodiments of the present invention. In embodiments that use two conductive patterns, the first conductive pattern 420 and the second conductive pattern 430 may be offset vertically, horizontally, and/or angularly relative to one another (as depicted in FIG. 6E). The offset between the first conductive pattern 420 and the second conductive pattern 430 may vary based on an application or a design. One of ordinary skill in the art will recognize that the first conductive pattern 420 and the second conductive pattern 430 may be disposed on substrate or substrates 410 using any process or processes suitable for disposing the conductive patterns on the substrate or substrates 410 in accordance with one or more embodiments of the present invention.

In touch sensor applications, a touch sensor (e.g., 130 of FIG. 1) should not significantly impede the transmission of the image (not shown) of the underlying display device (e.g., 110 of FIG. 1) or otherwise draw attention to the touch sensor itself. As such, great care must be taken in the design of a touch sensor comprised of non-transparent conductors so that it is not readily apparent to an end user under normal operating conditions. However, a touch sensor comprised of non-transparent conductors may be somewhat visible for a variety of reasons. Despite best efforts to reduce the visibility of a given conductive pattern by, for example, size, shape, stack up, and/or design of the conductive pattern, when one or more conductive patterns overlay one another, such as, for example, in a touch sensor embodiment where conductive patterns (e.g., 420, 430 of FIG. 4) may be disposed on opposing sides of a transparent substrate (e.g., 410 of FIG. 4), the one or more overlapping conductive patterns are periodic and offset from one another in a manner that generates Moiré interference (not shown) that draws the user's eye to the one or more conductive patterns and renders the touch sensor itself more visibly apparent.

Moiré interference is the perception of patterns caused by overlapping images, where the patterns perceived are not part of the images themselves. Moiré interference is typically generated when identical or near identical patterns, such as conductive patterns of a touch sensor, are overlaid and displaced or rotated relative to one another. As noted above, touch sensors commonly employ conductive patterns that are periodic, substantially similar to one another in design, disposed on opposing sides of a transparent substrate or substrates, and offset from one another, making them prone to the generation of Moiré interference. In touch sensor applications, the pixel array structure of the underlying display device and the placement of the touch sensor relevant to the pixel array structure may also contribute to the generation of Moiré interference. When the conductive patterns of the touch sensor are periodic and uniform, the probability of the pixel array structure lining up just right with some part of the touch sensor, thereby generating Moiré interference, is substantial. Depending on the spacing between conductors, Moiré interference may be visible not only when the underlying display device is turned on and is transmitting an image through the touch sensor, but may be visible when the underlying display device is turned off in a reflective mode. As such, while efforts to reduce the visibility of the conductive patterns themselves are helpful, they do not address the issue of Moiré interference and the degradation of visual quality that accompanies it in touch sensor applications.

Accordingly, in one or more embodiments of the present invention, a metal mesh touch sensor with randomized channel displacement reduces or eliminates Moiré interference which substantially reduces or eliminates the visibility of a conductive pattern or patterns and a touch sensor in which they may be disposed.

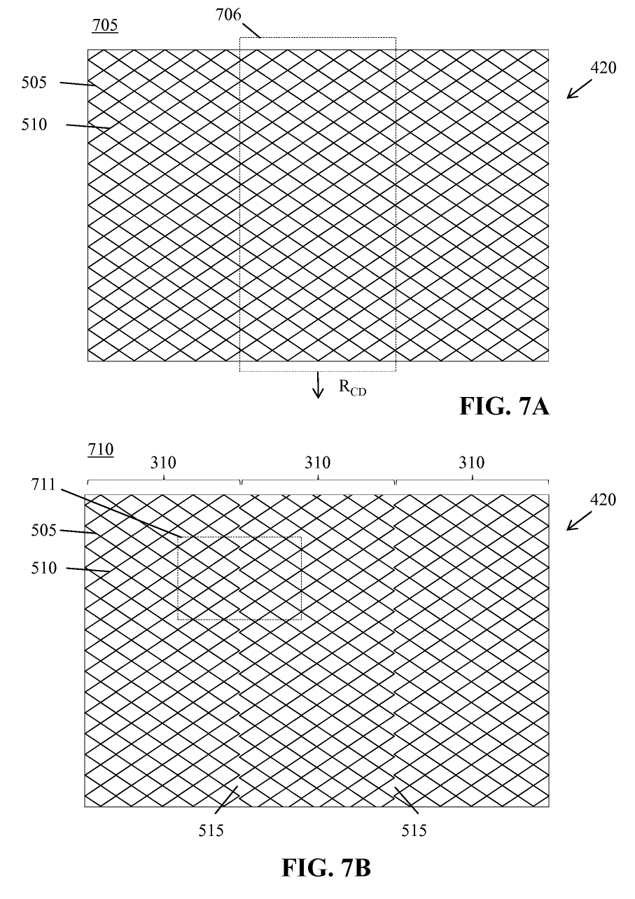

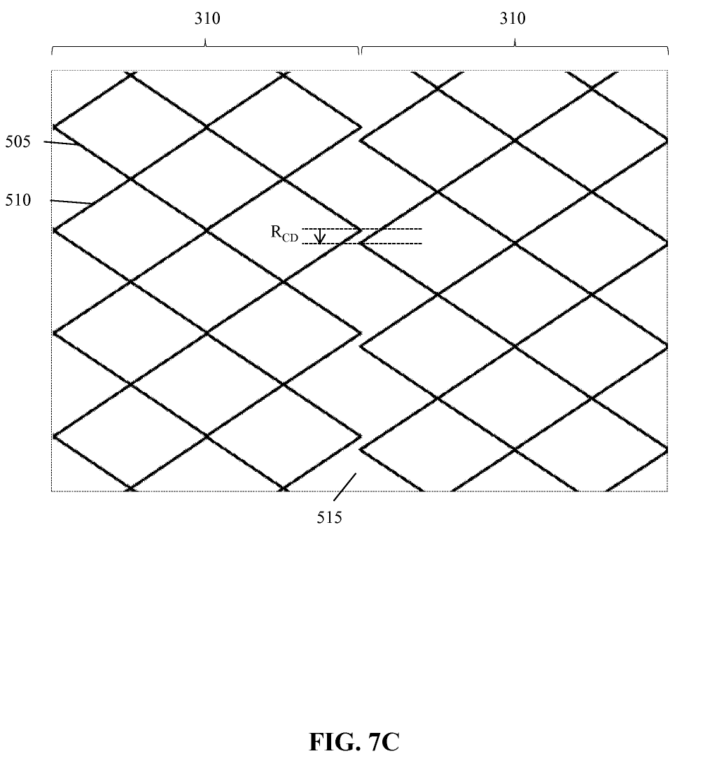

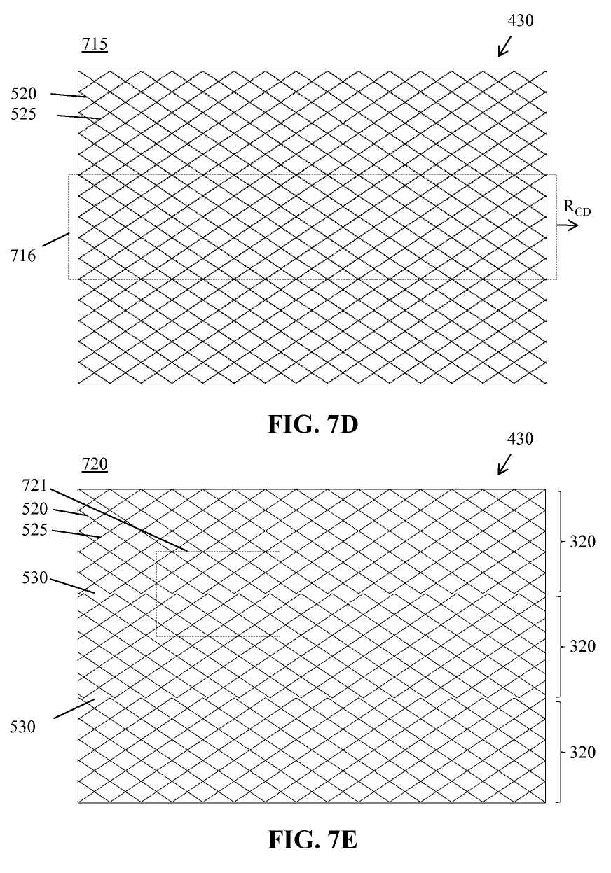

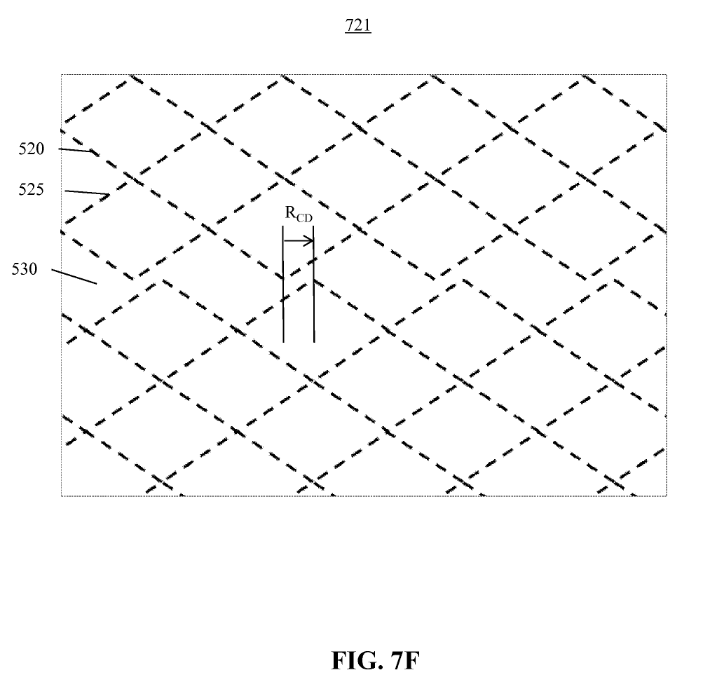

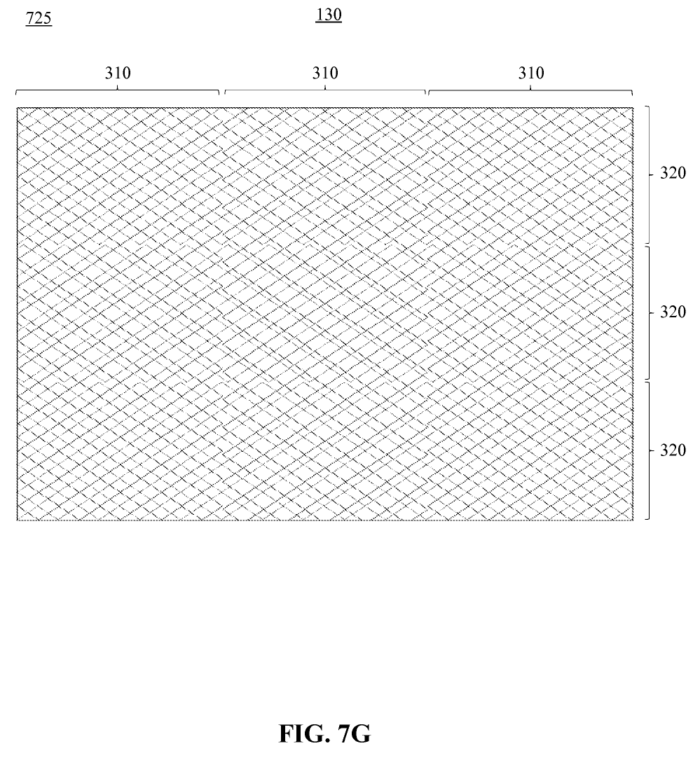

FIG. 7A shows a portion 705 of a representation of a first conductive pattern 420 in accordance with one or more embodiments of the present invention. A representation of the first conductive pattern 420 may be generated in, for example, a software application. In certain embodiments, the representation of the first conductive pattern 420 may be generated by placing a first plurality of representations of parallel conductive lines oriented in a first direction 505. In certain embodiments, the first plurality of representations of parallel conductive lines oriented in the first direction 505 may have fixed pitch between adjacent representations of parallel conductive lines 505 (as depicted in FIG. 7A). In other embodiments, the first plurality of representations of parallel conductive lines oriented in the first direction 505 may have randomized pitch (not shown) between adjacent representations of parallel conductive lines 505 as set out in U.S. patent application Ser. No. 14/680,763, filed on Apr. 7, 2015. A first plurality of representations of parallel conductive lines oriented in a second direction 510 may be placed. In certain embodiments, the first plurality of representations of parallel conductive lines oriented in the second direction 510 may have fixed pitch between adjacent representations of parallel conductive lines 510 (as depicted in FIG. 7A). In other embodiments, the first plurality of representations of parallel conductive lines oriented in the second direction 510 may have randomized pitch (not shown) between adjacent representations of parallel conductive lines 510 as set out in U.S. patent application Ser. No. 14/680,763, filed on Apr. 7, 2015. The first plurality of representations of parallel conductive lines oriented in the first direction 505 and the first plurality of representations of parallel conductive lines oriented in the second direction 510 may form a representation of a first mesh. Based on an angle of intersection, that may vary based on an application or design, the first mesh may be a rectangle-type mesh (not shown) or a parallelogram-type mesh (as depicted in FIG. 7A). Each placed representation of a parallel conductive line 505, 510 in the representation of the first conductive pattern 420 may have a line width of less than 10 micrometers.

In other embodiments, the representation of the first conductive pattern 420 may be generated by placing any one or more of a predetermined orientation of line segments, a random orientation of line segments, curved line segments, polygons, or any other shape or pattern suitable for use as a touch sensor conductive pattern. One of ordinary skill in the art will recognize that the representation of the first conductive pattern 420 may vary based on an application or design in accordance with one or more embodiments of the present invention.

The representation of the first conductive pattern 420 may be partitioned into a plurality of representations of column channels (not shown). As shown in FIG. 7A, the outline 706 of a representation of a column channel may be identified to break connectivity and apply a random channel displacement, R_{CD}.

Continuing, FIG. 7B shows a portion 710 of a representation of a first conductive pattern 420 with a random channel displacement in accordance with one or more embodiments of the present invention. As shown in FIG. 7B, the representation of the first conductive pattern 420 may be partitioned into a plurality of representations of column channels 310 by breaking connectivity between a given representation of a column channel 310 and adjacent representations of column channels 310. In the embodiment depicted, the outline (706 of FIG. 7A) of the selected representation of column channel 310 was used to apply a random channel displacement, R_{CD}, which breaks 515 connectivity with the adjacent representations of column channels 310. However, in other embodiments not shown, the outline (706 of FIG. 7A) of the selected representation of column channel 310 may be used as a void to break connectivity with the adjacent representations of column channels 310 prior to applying a random channel displacement, R_{CD}. In certain embodiments, a random channel displacement, R_{CD}, may be a randomly generated displacement, or shift, of the selected representation of a column channel 310 up or down in a direction that generally flows with the orientation of the representation of the column channel 310. A random channel displacement, R_{CD}, may be generated for each representation of a column channel 310 to which a random channel displacement, R_{CD}, is to be applied. In certain embodiments, a random channel displacement, R_{CD}, may be generated for a selected representation of a column channel 310 by generating a random number in a range between 1 micrometer and 500 micrometers in an up or down direction relative to the original placement of the selected representation of column channel 310. In other embodiments, a random channel displacement, R_{CD}, may be generated for a selected representation of a column channel 310 by generating a random number in a range between 500 micrometers and 1500 micrometers in an up or down direction relative to the original placement of the selected representation of column channel 310. One of ordinary skill in the art will recognize that a range of a random channel displacement, R_{CD}, may vary based on an application or design in accordance with one or more embodiments of the present invention. One of ordinary skill in the art will also recognize that, while conventional methods of generating random numbers with computers are not truly random, they may be generated in a way that is sufficiently random for the purpose of generating random channel displacements in accordance with one or more embodiments of the present invention.

As shown in FIG. 7B, when a random channel displacement, R_{CD}, is applied to at least one representation of a column channel 310, the constituent representations of parallel conductive lines 505, 510 are broken up into smaller line segments. As more random channel displacements are applied to other representations of column channels 310, the first mesh is significantly randomized such that the representation of the first conductive pattern 420 is substantially less periodic and is consequently less prone to the generation of Moiré interference. In addition, the channel breaks 515, or space between adjacent representations of column channels 310, generated by shifting a selected representation of a column channel 310 tends to break up the space of a conventional channel break (515 of FIG. 6B), rendering the channel breaks 515 less discernible to an end user. This advantageously reduces the visibility of the first conductive pattern 420 and a touch sensor in which it may be disposed.

While the embodiment depicted in FIG. 7B shows a portion 710 of a representation of the first conductive pattern 420 that is partitioned into three distinct column channels 310, the representation of the first conductive pattern 420 may include a number of column channels 310 that may vary based on an application or design. In certain embodiments, a random channel displacement may be applied to each of alternating column channels 310, such as, for example, going from left to right, the first, third, fifth, seventh, etc. column channels 310 (not shown). In other embodiments, a random channel displacement may be applied to each of alternating column channels 310 such as, for example, going from left to right, the second, fourth, sixth, etc. column channels 310 (not shown). One of ordinary skill in the art will recognize that a random channel displacement may be applied in other ways in accordance with one or more embodiments of the present invention.

Continuing, FIG. 7C shows a zoomed in view 711 of a portion 710 of a representation of a first conductive pattern 420 with a random channel displacement, R_{CD}, in accordance with one or more embodiments of the present invention. In the zoomed in view 711, you can see how the selected column channel 310 was displaced, in this instance in a downward direction from its original placement by a random channel displacement, R_{CD}.

Continuing, FIG. 7D shows a portion 715 of a representation of a second conductive pattern 430 in accordance with one or more embodiments of the present invention. A representation of the second conductive pattern 430 may be generated in, for example, a software application. In certain embodiments, the representation of the second conductive pattern 430 may be generated by placing a second plurality of representations of parallel conductive lines oriented in a first direction 520. In certain embodiments, the second plurality of representations of parallel conductive lines oriented in the first direction 520 may have fixed pitch between adjacent representations of parallel conductive lines 520 (as depicted in FIG. 7D). In other embodiments, the second plurality of representations of parallel conductive lines oriented in the first direction 520 may have randomized pitch (not shown) between adjacent representations of parallel conductive lines 520 as set out in U.S. patent application Ser. No. 14/680,763, filed on Apr. 7, 2015. A second plurality of representations of parallel conductive lines oriented in a second direction 525 may be placed. In certain embodiments, the second plurality of representations of parallel conductive lines oriented in the second direction 525 may have fixed pitch between adjacent representations of parallel conductive lines 525 (as depicted in FIG. 7D). In other embodiments, the second plurality of representations of parallel conductive lines oriented in the second direction 525 may have randomized pitch (not shown) between adjacent representations of parallel conductive lines 525 as set out in U.S. patent application Ser. No. 14/680,763, filed on Apr. 7, 2015. The second plurality of representations of parallel conductive lines oriented in the first direction 520 and the second plurality of representations of parallel conductive lines oriented in the second direction 525 may form a representation of a second mesh. Based on the angle of intersection, that may vary based on an application or design, the second mesh may be a rectangle-type mesh (not shown) or a parallelogram-type mesh (as depicted in FIG. 7D). Each placed representation of a parallel conductive line in the second conductive pattern 430 may have a line width of less than 10 micrometers.

In other embodiments, the representation of the second conductive pattern 430 may be generated by placing any one or more of a predetermined orientation of line segments, a random orientation of line segments, curved line segments, polygons, or any other shape or pattern suitable for use as a touch sensor conductive pattern. One of ordinary skill in the art will recognize that the second conductive pattern 430 may vary based on an application or design in accordance with one or more embodiments of the present invention.

The representation of the second conductive pattern 430 may be partitioned into a plurality of representations of row channels (not shown). As shown in FIG. 7D, the outline 716 of a representation of a row channel may be identified to break connectivity and apply a random channel displacement, R_{CD}.

Continuing, FIG. 7E shows a portion 720 of a representation of a second conductive pattern 430 with a random channel displacement in accordance with one or more embodiments of the present invention. As shown in FIG. 7E, the representation of the second conductive pattern 430 may be partitioned into a plurality of representations of row channels 320 by breaking connectivity between a given representation of a row channel 320 and adjacent representations of row channels 320. In the embodiment depicted, the outline (716 of FIG. 7D) of the selected representation of row channel 320 was used to apply a random channel displacement, R_{CD}, which breaks 530 connectivity with the adjacent representations of row channels 320. However, in other embodiments not shown, the outline (716 of FIG. 7D) of the representation of the row channel 320 may be used as a void to break connectivity with the adjacent representations of row channels 320 prior to applying a random channel displacement, R_{CD}. In certain embodiments, a random channel displacement, R_{CD}, may be a randomly generated displacement, or shift, of the selected representation of row channel 320 to the left or the right in a direction that generally flows with the orientation of the representation of the row channel 320. A random channel displacement, R_{CD}, may be generated for each row channel 320 to which a random channel displacement is to be applied. In certain embodiments, a random channel displacement, R_{CD}, may be generated for a selected row channel 320 by generating a random number in a range between 1 micrometer and 500 micrometers in a left or right direction relative to the original placement of the selected representation of row channel 320. In other embodiments, a random channel displacement, R_{CD}, may be generated for a selected row channel 320 by generating a random number in a range between 500 micrometers and 1500 micrometers in a left or right direction relative to the original placement of the selected representation of row channel 320. One of ordinary skill in the art will recognize that a range of a random channel displacement, R_{CD}, may vary in other ways based on an application or design in accordance with one or more embodiments of the present invention. One of ordinary skill in the art will also recognize that, while conventional methods of generating random numbers with computers are not truly random, they may be generated in a way that is sufficiently random for the purpose of generating random channel displacements in accordance with one or more embodiments of the present invention.

As shown in FIG. 7E, when a random channel displacement, R_{CD}, is applied to at least one representation of a row channel 320, the constituent representations of parallel conductive lines 520, 525 are broken up into smaller line segments. As more random channel displacements are applied to other representations of row channels 320, the second mesh is significantly randomized such that the representation of the second conductive pattern 430 is substantially less periodic and is consequently less prone to the generation of Moiré interference. In addition, the channel breaks 530, or space between adjacent representations of row channels 320, generated by shifting a selected representation of row channel 320 tends to break up the space of a conventional channel break (530 of FIG. 6D), rendering the channel breaks 530 less discernible to an end user. This advantageously reduces the visibility of the second conductive pattern 430 and a touch sensor in which it may be disposed.

While the embodiment depicted in FIG. 7E shows a portion 720 of a representation of the second conductive pattern 430 that is partitioned into three distinct row channels 320, the representation of the second conductive pattern 430 may include a number of row channels 320 that may vary based on an application or design. In certain embodiments, a random channel displacement may be applied to each of alternating row channels 320, such as, for example, going from bottom to top, the first, third, fifth, seventh, etc. row channels 320 (not shown). In other embodiments, a random channel displacement may be applied to each of alternating row channels 320 such as, for example, going from bottom to top, the second, fourth, sixth, etc. row channels 320 (not shown). One of ordinary skill in the art will recognize that a random channel displacement may be applied in other ways in accordance with one or more embodiments of the present invention.

Continuing, FIG. 7F shows a zoomed in view 721 of a portion 720 of a representation of a second conductive pattern 430 with a random channel displacement, R_{CD}, in accordance with one or more embodiments of the present invention. In the zoomed in view 721, you can see how the selected row channel 320 was displaced, in this instance horizontally to the right from its original placement, by a random channel displacement, R_{CD}.

While not explicitly shown in the FIGS. 7A through 7F, a first plurality of representations of channel pads (not shown) may be placed in connection to the corresponding plurality of representations of column channels 310. A first plurality of representations of interconnect conductive lines (not shown) may be placed and route the plurality of representations of column channels 310 to a corresponding first plurality of representations of interface connectors (not shown). Similarly, a second plurality of representations of channel pads (not shown) may be placed in connection to the corresponding plurality of representations of row channels 320. A second plurality of representations of interconnect conductive lines (not shown) may be placed and route the plurality of representations of row channels 320 to a corresponding second plurality of representations of interface connectors (not shown). One of ordinary skill in the art will recognize that other bezel circuitry may be used to provide the appropriate connectivity for a given conductive pattern or touch sensor in which it may be disposed in accordance with one or more embodiments of the present invention.

Continuing, FIG. 7G shows a portion 725 of a metal mesh touch sensor 130 with randomized channel displacement in accordance with one or more embodiments of the present invention. In certain embodiments, a metal mesh touch sensor 130b may be formed by disposing a first conductive pattern 420 on a first side of a transparent substrate (e.g., transparent substrate 410) such as, for example, a PET substrate. The first conductive pattern 420 may be partitioned into a plurality of column channels 310. A random channel displacement may be applied to at least one column channel 310. When applied to more than one column channel 310, a random channel displacement may be applied to, for example, every column channel 310, alternating column channels 310, or certain column channels 310. A second conductive pattern 430 may be disposed on a second side of the transparent substrate. The second conductive pattern 430 may be partitioned into a plurality of row channels 320. A random channel displacement may be applied to at least one row channel 320. When applied to more than one row channel 320, a random channel displacement may be applied to, for example, every row channel 320, alternating row channels 320, or certain row channels 320.

A first plurality of channel pads (not shown) may be in electrical connection with the corresponding plurality of column channels 310. For example, a first channel pad may be in electrical connection with a first column channel 310. A first plurality of interconnect conductive lines (not shown) may provide electrical connectivity between the first plurality of channel pads (not shown) and a corresponding first plurality of interface connectors (not shown). For example, one or more interconnect conductive lines (not shown) may provide electrical connectivity between a first channel pad (not shown) and a first interface connector (not shown). Similarly, a second plurality of channel pads (not shown) may be in electrical connection with the corresponding plurality of row channels 320. A second plurality of interconnect conductive lines (not shown) may provide electrical connectivity between the second plurality of channel pads (not shown) and a corresponding second plurality of interface connectors (not shown). The first conductive pattern 420 may comprise conductive lines having a line width less than 10 micrometers. Similarly, the second conductive pattern 430 may comprise conductive lines having a line width less than 10 micrometers.

In other embodiments, a metal mesh touch sensor 130 may be formed by disposing a first conductive pattern 420 on a side of a first transparent substrate (e.g., transparent substrate 410) such as, for example, a PET substrate. The first conductive pattern 420 may be partitioned into a plurality of column channels 310. A random channel displacement may be applied to at least one column channel 310. When applied to more than one column channel 310, a random channel displacement may be applied to, for example, every column channel 310, alternating column channels 310, or certain column channels 310. A second conductive pattern 430 may be disposed on a side of a second transparent substrate (e.g., transparent substrate 410) such as, for example, a PET substrate. The second conductive pattern 430 may be partitioned into a plurality of row channels 320. A random channel displacement may be applied to at least one row channel 320. When applied to more than one row channel 320, a random channel displacement may be applied to, for example, every row channel 320, alternating row channels 320, or certain row channels 320. The first transparent substrate may be bonded to the second transparent substrate.

A first plurality of channel pads (not shown) may be in electrical connection with the corresponding plurality of column channels 310. For example, a first channel pad may be in electrical connection with a first column channel 310. A first plurality of interconnect conductive lines (not shown) may provide electrical connectivity between the first plurality of channel pads (not shown) and a corresponding first plurality of interface connectors (not shown). For example, one or more interconnect conductive lines (not shown) may provide electrical connectivity between a first channel pad (not shown) and a first interface connector (not shown). Similarly, a second plurality of channel pads (not shown) may be in electrical connection with the corresponding plurality of row channels 320. A second plurality of interconnect conductive lines (not shown) may provide electrical connectivity between the second plurality of channel pads (not shown) and a corresponding second plurality of interface connectors (not shown). The first conductive pattern 420 may comprise conductive lines having a line width less than 10 micrometers. Similarly, the second conductive pattern 430 may comprise conductive lines having a line width less than 10 micrometers.

One of ordinary skill in the art will recognize that metal mesh touch sensor 130 may be formed in other ways in accordance with one or more embodiments of the present invention. In addition, one of ordinary skill in the art will also recognize that the other methods of reducing Moiré interference, such as randomized pitch, may be advantageously used in a combination in whole or in part with the above-noted method to further reduce Moiré interference and reduce the visibility of a conductive pattern or touch sensor in which it may be disposed. For example, when generating a representation of a conductive pattern, the pitch may be randomized as disclosed in parent application U.S. patent application Ser. No. 14/680,763, filed on Apr. 7, 2015, entitled “METAL MESH TOUCH SENSOR WITH RANDOMIZED PITCH”, which is hereby incorporated by reference in its entirety. In such embodiments, a representation of a conductive pattern with random pitch may be used as a starting point for the application of random channel displacement as described herein.

Advantages of one or more embodiments of the present invention may include one or more of the following:

In one or more embodiments of the present invention, a metal mesh touch sensor with randomized channel displacement reduces or eliminates Moiré interference.

In one or more embodiments of the present invention, a metal mesh touch sensor with randomized channel displacement reduces or eliminates the visual appearance of channel breaks.

In one or more embodiments of the present invention, a metal mesh touch sensor with randomized channel displacement does not negatively impact the transmittance of the image of the underlying display device and does not draw the eye to the one or more conductive patterns of the touch sensor.

In one or more embodiments of the present invention, a metal mesh touch sensor with randomized channel displacement provides the same or substantially the same amount of macro light transmittance as compared to a conventional metal mesh touch sensor.

In one or more embodiments of the present invention, a metal mesh touch sensor with randomized channel displacement provides the same or substantially the same amount of haze as comparted to a conventional metal mesh touch sensor.

In one or more embodiments of the present invention, a metal mesh touch sensor with randomized channel displacement may be used in combination with one or more other techniques to reduce Moiré interference and visibility of the touch sensor.

In one or more embodiments of the present invention, a metal mesh touch sensor with randomized channel displacement may be compatible with any process suitable for designing and/or fabricating non-transparent conductive patterns on a transparent substrate.

In one or more embodiments of the present invention, a metal mesh touch sensor with randomized channel displacement may be designed using existing software applications. For example, one or more of the conductive patterns having conductive lines with randomized channel displacement may be designed in the same CAD software application used to design a conductive pattern of a conventional metal mesh touch sensor.

In one or more embodiments of the present invention, a metal mesh touch sensor with randomized channel displacement may be fabricated using existing fabrication methods. For example, a flexographic printing process may be used to print a catalytic ink image of one or more conductive patterns on a transparent substrate that are metallized by an electroless plating process to produce one or more conductive patterns on substrate.

In one or more embodiments of the present invention, a metal mesh touch sensor with randomized channel displacement reduces the effects of pixelization when writing an image of a conductive pattern with randomized channel displacement on a thermal imaging layer using a laser beam as part of the process of fabricating a flexographic printing plate.

In one or more embodiments of the present invention, a metal mesh touch sensor with randomized channel displacement does not increase the material cost of fabrication over a conventional metal mesh touch sensor.

In one or more embodiments of the present invention, a metal mesh touch sensor with randomized channel displacement does not increase the time of fabrication over a conventional metal mesh touch sensor.

In one or more embodiments of the present invention, a metal mesh touch sensor with randomized channel displacement does not increase the complexity of fabrication over a conventional metal mesh touch sensor.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method of designing a metal mesh touch sensor with randomized channel displacement comprising:
generating a representation of a first conductive pattern;
partitioning the representation of the first conductive pattern into a plurality of representations of column channels;
applying a random channel displacement to at least one column channel;
generating a representation of a second conductive pattern;
partitioning the representation of the second conductive pattern into a plurality of representations of row channels; and
applying a random channel displacement to at least one row channel.

2. The method of claim 1, further comprising:
placing a first plurality of representations of channel pads in connection to the corresponding plurality of representations of column channels; and
placing a first plurality of representations of interconnect conductive lines that route the plurality of representations of column channels to a corresponding first plurality of representations of interface connectors.

3. The method of claim 1, further comprising:
placing a second plurality of representations of channel pads in connection to the corresponding plurality of representations of row channels; and
placing a second plurality of representations of interconnect conductive lines that route the plurality of representations of row channels to a corresponding second plurality of representations of interface connectors.

4. The method of claim 1, wherein generating the representation of the first conductive pattern comprises:
placing a first plurality of representations of parallel conductive lines oriented in a first direction; and
placing a first plurality of representations of parallel conductive lines oriented in a second direction,
wherein the first plurality of representations of parallel conductive lines oriented in the first direction and the first plurality of representations of parallel conductive lines oriented in the second direction form a representation of a first mesh.

5. The method of claim 1, wherein generating the representation of the second conductive pattern comprises:
placing a second plurality of representations of parallel conductive lines oriented in a first direction; and
placing a second plurality of representations of parallel conductive lines oriented in a second direction,
wherein the second plurality of representations of parallel conductive lines oriented in the first direction and the second plurality of representations of parallel conductive lines oriented in the second direction form a representation of a second mesh.

6. The method of claim 1, wherein a random channel displacement is applied to alternating column channels.

7. The method of claim 1, wherein a random channel displacement is applied to alternating row channels.

8. The method of claim 4, wherein each placed representation of a parallel conductive line in the representation of the first conductive pattern has a line width less than 10 micrometers.

9. The method of claim 5, wherein each placed representation of a parallel conductive line in the representation of the second conductive pattern has a line width less than 10 micrometers.

10. A metal mesh touch sensor with randomized channel displacement comprising:
a transparent substrate;
a first conductive pattern disposed on a first side of the transparent substrate, wherein the first conductive pattern is partitioned into a plurality of column channels and at least one column channel has a random channel displacement; and
a second conductive pattern disposed on a second side of the transparent substrate, wherein the second conductive pattern is partitioned into a plurality of row channels and at least one row channel has a random channel displacement.

11. The metal mesh touch sensor of claim 10, further comprising:
a first plurality of channel pads in electrical connection with the corresponding plurality of column channels; and
a first plurality of interconnect conductive lines that provide electrical connectivity between the first plurality of channel pads and a corresponding first plurality of interface connectors.

12. The metal mesh touch sensor of claim 10, further comprising:
a second plurality of channel pads in electrical connection with the corresponding plurality of row channels; and
a second plurality of interconnect conductive lines that provide electrical connectivity between the second plurality of channel pads and a corresponding second plurality of interface connectors.

13. The metal mesh touch sensor of claim 10, wherein the first conductive pattern comprises conductive lines having a line width less than 10 micrometers.

14. The metal mesh touch sensor of claim 10, wherein the second conductive pattern comprises conductive lines having a line width less than 10 micrometers.

15. The metal mesh touch sensor of claim 10, wherein a random channel displacement is applied to alternating column channels.

16. The metal mesh touch sensor of claim 10, wherein a random channel displacement is applied to alternating row channels.

17. The metal mesh touch sensor of claim 10, wherein the transparent substrate comprises polyethylene terephthalate.

18. A metal mesh touch sensor with randomized channel displacement comprising:
a first transparent substrate;
a first conductive pattern disposed on a side of the first transparent substrate, wherein the first conductive pattern is partitioned into a plurality of column channels and at least one column channel has a random channel displacement;
a second transparent substrate; and
a second conductive pattern disposed on a second side of the transparent substrate, wherein the second conductive pattern is partitioned into a plurality of row channels and at least one row channel has a random channel displacement,
wherein the first transparent substrate is bonded to the second transparent substrate.

19. The metal mesh touch sensor of claim 18, further comprising:
a first plurality of channel pads in electrical connection with the corresponding plurality of column channels; and
a first plurality of interconnect conductive lines that provide electrical connectivity between the first plurality of channel pads and a corresponding first plurality of interface connectors.

20. The metal mesh touch sensor of claim 18, further comprising:
a second plurality of channel pads in electrical connection with the corresponding plurality of row channels; and
a second plurality of interconnect conductive lines that provide electrical connectivity between the second plurality of channel pads and a corresponding second plurality of interface connectors.

21. The metal mesh touch sensor of claim 18, wherein the first conductive pattern comprises conductive lines having a line width less than 10 micrometers.

22. The metal mesh touch sensor of claim 18, wherein the second conductive pattern comprises conductive lines having a line width less than 10 micrometers.

23. The metal mesh touch sensor of claim 18, wherein a random channel displacement is applied to alternating column channels.

24. The metal mesh touch sensor of claim 18, wherein a random channel displacement is applied to alternating row channels.

25. The metal mesh touch sensor of claim 18, wherein the transparent substrates comprise polyethylene terephthalate.
